(19) United States
(12) Patent Application Publication
(10) Pub. No.: US 2007/0130096 A1
(43) Pub. Date: Jun. 7, 2007

(54) Fault detection in artificial intelligence based air data systems

(75) Inventors: Andrew John Selvig, Prior Lake, MN (US); Brian D. Matheis, Lakeville, MN (US); Ryan J. Curtiss, Stoughton, WI (US)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Rosemount Aerospace, Inc., Burnsville, MN (US)

(21) Appl. No.: 11/291,461

(22) Filed: Dec. 1, 2005

(51) Int. Cl. G06N 5/00

(52) U.S. Cl. 706/45

(57) ABSTRACT

A method and apparatus for detecting a fault in a sensor for an air data system which uses artificial intelligence to generate air data parameters is disclosed. The method and apparatus generate air data parameters as a function of measured values such as static pressures. The system also generates a fault detection value based upon the received value. The fault detection value is then input into a second network having artificial intelligence to determine if a sensor has experienced a fault.

### BACKGROUND OF THE INVENTION

The present invention relates generally to air data sensing systems, such as flush air data systems (FADS), for use on an air vehicle. More particularly, the present invention relates to methods and apparatus for providing fault isolation in artificial intelligence based air data sensing systems, such as neural network based FADS.

A FADS typically utilizes several flush or semi-flush static pressure ports on the exterior of an air vehicle (such as an aircraft) to measure local static pressures at various positions. The pressure or pressure values measured by the individual ports are combined using some form of artificial intelligence algorithm(s), e.g., neural networks (NNs) for instance, to provide corrected air data parameters for the air vehicle. Corrected air data parameters represent global values of these parameters for the air vehicle. In this context, the term “global” refers to the air data measured far away from the air vehicle, i.e., “far field.” In contrast, “local” parameters are measured at the surface of the air vehicle and are prone to flow field effects around the aircraft geometry. Local parameters are characterized, or corrected, in order to get global air data. Examples of these global air data parameters for the air vehicle include angle of attack (AOA), angle of sideslip (AOS), Mach number, etc. Other well known global air data parameters for the air vehicle can also be calculated. Another example of artificial intelligence algorithms which can be used with a FADS is support vector machines (SVMs), and artificial intelligence algorithms as referenced herein include these or other types of algorithms which learn by example.

Flush air data systems provide numerous advantages which make their use desirable for certain air vehicles or in certain environments. For example, the flush or semi-flush static pressure ports can result in less drag on the air vehicle than some other types of pressure sensing devices. Additionally, the flush or semi-flush static pressure sensing ports experience less ice build-up than some other types of pressure sensing devices. Other advantages of a FADS can include, for example, lower observability than some probe-style air data systems.

Consider a FADS which uses N flush static pressure ports for use on an aircraft. The individual ports each measure a single local pressure value related to their respective locations on the aircraft. Using neural networks or other artificial intelligence algorithms, these N pressure values can be used as inputs to provide the individual global air data parameters necessary for the air data system. To ensure accurate performance and to increase reliability, an important part of the overall air data system is the ability to isolate and detect faults to maintain accuracy and safety levels. Blocked ports or drifting sensors are examples of failures of hardware. Drifting sensors are sensors with an output which changes over time, due to calibration or other problems, relative to a desired or baseline output for a particular set of conditions. Undetected faults reduce the safety of the overall system, and since aircraft global parameters are derived using artificial intelligence with a large number of pressure sensing ports as inputs, failure of one or more of these ports can be difficult to identify and isolate. Therefore, there is a need for methods of fault isolation in artificial intelligence based FADS or other air data systems.

### SUMMARY OF THE INVENTION

A method and apparatus for detecting a fault in a sensor for an air data system which uses artificial intelligence to generate air data parameters is disclosed. The method and apparatus generate air data parameters as a function of measured values such as static pressures. The system also generates a fault detection value based upon a received value. The fault detection value is then input into a second network having artificial intelligence to determine if a sensor has experienced a fault.

Embodiments of the method and apparatus generate the fault detection value based on a received air data parameter. In one embodiment the received air data parameter is processed through the network to generate additional air data parameters. These additional air data parameters are then passed to an inverse look-up table to identify a predicted air data parameter that is associated with the additional air data parameters. Then a difference between the measured and predicted air data parameters is input into the second network having artificial intelligence. In a second embodiment a non-dimensional value for the measured air data parameter is calculated. This is calculated by dividing the measured air data parameter by the average of the same air data parameter measured by the sensors in the system. This value is input into the second network.

### BRIEF DESCRIPTION OF THE DRAWINGS

FIG. 1 is a diagrammatic illustration of flush air data pressure sensing ports on an air vehicle as seen from top and bottom views, respectively, in an example embodiment.

FIG. 2 is a diagrammatic illustration of a flush air data system (FADS) which is configured to implement fault isolation methods of the present invention.

FIG. 3 is a diagrammatic illustration of a neural network, of the type which can be used in the FADS shown in FIG. 2, which uses pressure readings from flush static ports as inputs and which generates as an output one or more desired air data parameters.

FIG. 4 is a block diagram illustrating the components of a FADS according to one embodiment of the present invention.

FIG. 5 is flow diagram illustrating the steps of fault detection according to the FADS of FIG. 4.

FIG. 6 is a block diagram illustrating the components of a FADS according to one embodiment of the present invention.

FIG. 7 is flow diagram illustrating the steps of fault detection according to the FADS of FIG. 6.

FIG. 8 is a graph illustrating a tansig equation useable by a fault detection neural network.

### DETAILED DESCRIPTION OF THE PREFERRED EMBODIMENTS

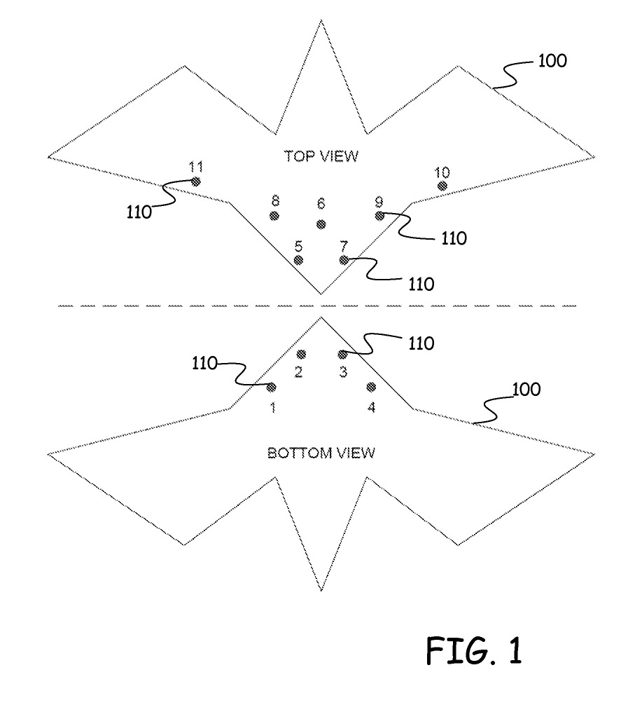

FIG. 1 is a diagrammatic illustration, in top and bottom views, of an aircraft or air vehicle 100 which employs a flush air data system (FADS) in accordance with embodiments of the present invention. Flush air data systems are generally known in the art. For example, aspects of one such FADS is described in U.S. Pat. No. 6,253,166 issued to Whitmore et al. on Jun. 26, 2001 and entitled STABLE ALGORITHM FOR ESTIMATING AIRDATA FROM FLUSH SURFACE PRESSURE MEASUREMENTS. Other examples of FADS or aspects of FADS are described in: (1) Air Data Sensing from Surface Pressure Measurements Using a Neural Network, Method AIAA Journal, vol. 36, no. 11, pp. 2094-2101(8) (1 Nov. 1998) by Rohloff T. J., Angeles L., Whitmore S. A., and Catton I; (2) Fault-Tolerant Neural Network Algorithm for Flush Air Data Sensing, Journal of Aircraft, vol. 36, iss. 3, pp. 541-549(9) (1 May 1999) by Rohloff T. J., Whitmore S. A., and Catton I; (3) Fault Tolerance and Extrapolation Stability of a Neural Network Air-Data Estimator, Journal of Aircraft, vol. 36, iss. 3, pp. 571-576(6) (1 May 1999) by Rohloff T. J. and Catton I; and (4) Failure Management Scheme for Use in a Flush Air Data System, Aircraft Design 4, pp. 151-162 (2001) by C. V. Srinatha Sastry, K. S. Raman, and B. Lakshman Babu.

The FADS employed by air vehicle 100 includes, in one illustrated example, eleven flush (or semi-flush) static pressure sensing ports 110 positioned at various locations on the exterior of the vehicle. While FIG. 1 illustrates eleven static pressure sensing ports in particular locations, the particular number and locations of ports 110 can vary as desired for the particular air vehicle and application. Other examples of FADS as described herein use N static pressure sensing ports.

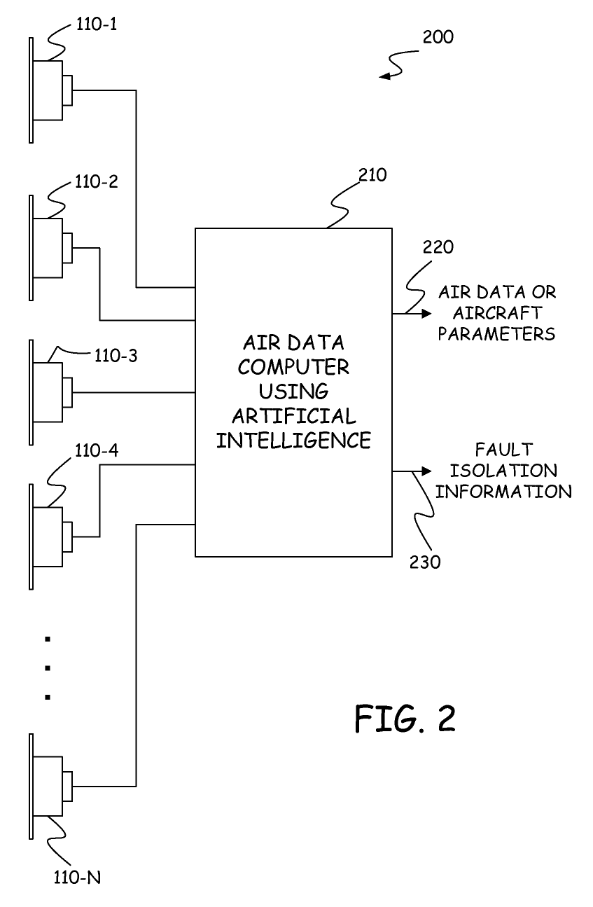

As noted previously, in a FADS, the pressure or pressure values measured by the individual ports 110 are combined, using some form of artificial intelligence algorithm(s) (neural networks, support vector machines, etc), to generate global air data parameters. When one or more of the ports 110 experiences a blockage or other fault, it is beneficial to be able to isolate the failed or faulted port in order to ensure that the system performs up to a desired or necessary standard. FIG. 2 is a diagrammatic illustration of a FADS 200, in accordance with embodiments of the present invention, which provides such fault isolation. System 200 is one example embodiment of the FADS used on air vehicle 100. While FIG. 2 illustrates flush static pressure sensing ports, it is intended to represent air data systems more generally, including those using other types of pressure sensing devices. For example, the illustrated air data system can be an air data system which uses more conventional strut mounted or probe type pressure sensors.

As illustrated in FIG. 2, FADS 200 includes N flush static ports 110 (numbered 110-1 through 110-N, respectively). The individual ports each measure a single pressure value related to their respective locations on the air vehicle 100. Using one or more neural networks or other artificial intelligence based algorithms implemented in air data computer circuitry 210, these N pressure values can be combined or used to generate one or more air data parameters 220 as desired. Examples of these air data parameters include, but are not limited to, angle of attack (AOA), angle of sideslip (AOS), and Mach number. As will be described below in greater detail, the artificial intelligence algorithms implemented by air data computer 210 also provide fault isolation information 230 which is indicative of blocked or otherwise faulted static pressure sensing ports.

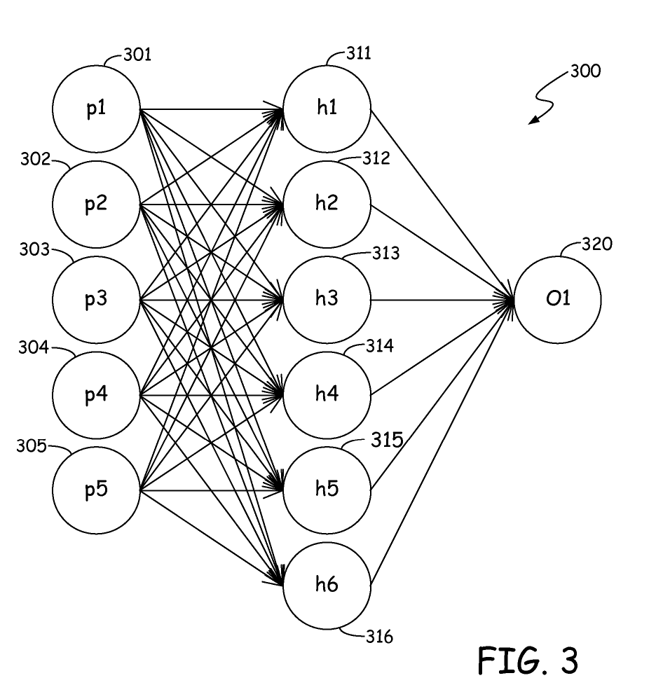

In accordance with one example embodiment of the invention, air data computer 210 is configured to implement neural networks such as the one illustrated in FIG. 3. In this example, assume that there are only five flush static ports (i.e., N=5) corresponding to ports 110 shown in FIGS. 1 and 2. As illustrated in FIG. 3, these five ports each generate a corresponding pressure reading pᵢ (for i between 1 and 5) which is provided as an input of a neural network 300. The five inputs corresponding to these five pressure readings are shown at reference numbers 301-305, respectively. The pressure readings at inputs 301-305 are then provided to internal nodes (for example nodes h1 through h6 shown at 311-316) of the neural network which apply predetermined weights, biases and transfer functions to the pressure readings to generate intermediate outputs. In this illustrated example, the intermediate outputs provided by internal nodes 311-316 are provided as inputs to output node 320. Output node 320 applies predetermined weights and/or a transfer function to the intermediate outputs to generate a particular air data parameter (designated “O1”) as an output. The air data parameter O1 generated at output node 320 is one of the air data parameters 220 provided as an output from air data computer 210 shown in FIG. 2.

Although not illustrated in FIG. 3, the intermediate outputs of nodes 311-316 can be provided to any number of desired layers of nodes within neural network 300. Further, any of a variety of different types of neural networks or other artificial intelligence algorithms can be used. Further still, as is understood in the art, the weighting and transfer functions applied by various nodes of the neural network are predetermined by training the neural network with a large number of data sets of known inputs and the corresponding desired outputs. In the case of an air data system, the sets of known inputs and their corresponding outputs can be obtained from flight test data, wind tunnel data, or other sources. Also, while only one air data parameter (“O1”) is output from neural network 300, other air data parameters can be provided by adding additional nodes and training the neural network accordingly. In the alternative, other separate neural networks can be used to generate the additional air data parameters.

It should be noted that an air data system such as the one illustrated in the above-described FIGS. is not limited to FADS. These methods can also be applied to fault isolation of any system that shows dependence between a set of variables, such as air data systems which use other types of pressure sensing probes or devices. These methods can also be applied to fault isolation in air data systems which provide global air data parameters as a function of inputs other than only static pressures. For example, other inputs to a neural network or other artificial intelligence algorithm include measured values indicative of control surface positions, control surface loading, hydraulic pressures or other forces, vehicle mass at take-off, vehicle mass balance, remaining fuel mass, engine thrust or thrust settings, global position system (GPS)/satellite information (altitude, speed, position), altitude or pressure-altitude from an on-board or remote source, air temperature from an on-board or remote source, vehicle acceleration from the inertial system or independent accelerometers, vehicle attitude from the inertial system or independent accelerometers, landing gear position (deployed or not), etc. Consequently, while in example embodiments the neural network inputs illustrated in FIGS. 2 and 3 are local static pressures, in other embodiments the inputs illustrated in these FIGS. represent other measured values such as one or more of the above-mentioned value types.

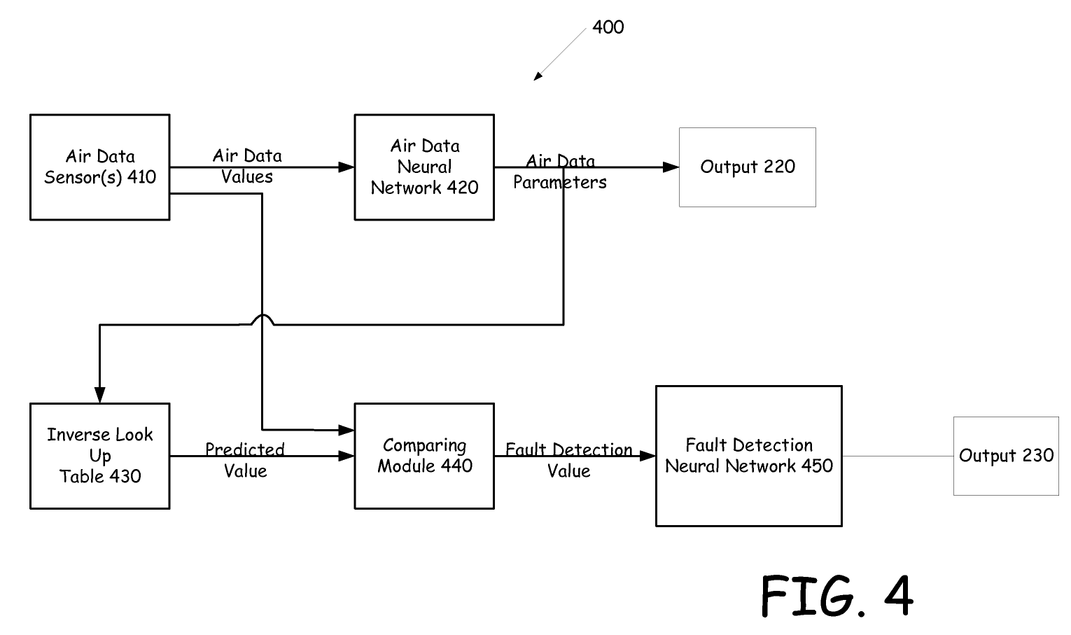

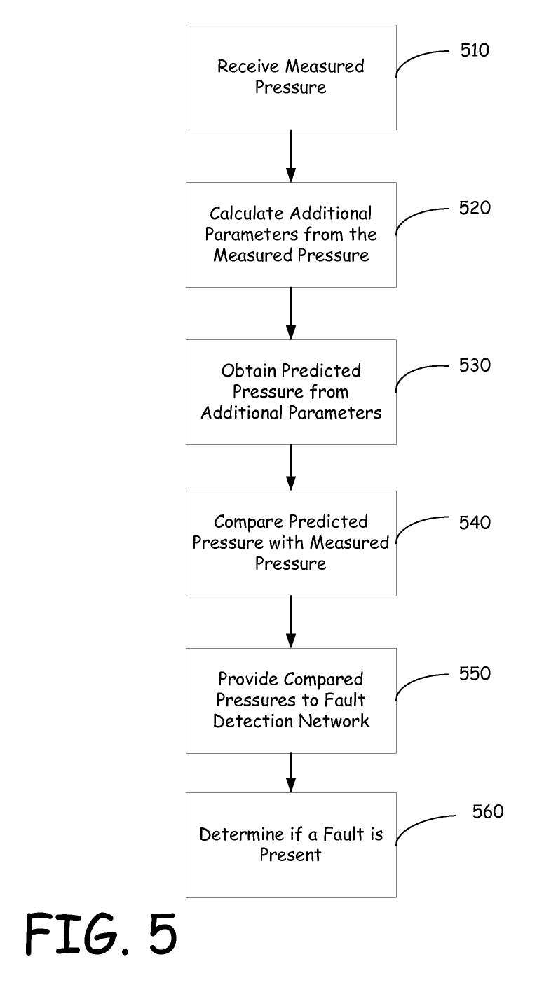

FIG. 4 is a block diagram illustrating the process and components for determining a fault according to one embodiment of the present invention. FIG. 5 is a flow diagram that illustrates steps performed according to one exemplary implementation of the embodiment of FIG. 4.

System 400 includes an air data sensor 410, an air data neural network 420, an inverse look up table 430, a comparing module 440, and a fault detection neural network 450. For purposes of simplicity the discussion in FIG. 4 will refer to a single measured value from sensor 410. However, those skilled in the art will readily recognize that the principles discussed in FIG. 4 apply when sensor 410 is representative of multiple sensors.

At the first step of the process sensor 410 provides an indication of a measured pressure to the air data neural network 420. This is illustrated at step 510. It should be noted that while air data neural network 420 is illustrated as a neural network other components can be substituted for network 420. For example, network 420 can be a component implementing other forms of artificial intelligence.

The data provided to the air data neural network 420 can be in a form that data is typically transmitted from the sensor 410 to the network 420. For purposes of this discussion it is assumed that the data transmitted from the sensor 410 is data indicative of a measured pressure. However, those skilled in the art will readily recognize that the sensor 410 can provide different or additional air data values to the air data network 420.

The air data neural network 420 receives the measured pressure from the air data sensor 410. From this measured pressure the air data neural network 420 calculates a number of additional air data parameters such as free stream flight conditions. In one embodiment the air data neural network 420 calculates four additional parameters. Those parameters can include static pressure (Ps), impact pressure (Qc), angle of attack (AOA), and angle of slip (AOS). However, the air data neural network can calculate more or less additional parameters. Further, network 420 can calculate other air data parameters than those listed above. The calculation of the additional parameters is illustrated at step 520.

Air data neural network 420 is a neural network that has been trained prior to the use of the system on an aircraft. Network 420 in one embodiment is trained on data sets that have been created from computational fluid dynamics (CFD), wind tunnel, and/or flight tests. Depending on the number of sensors present on the aircraft the data set for system 400 a number of multidimensional tables will exist. For example, a system having N pressure ports and M output values will consist of N M-dimensional tables that return a pressure value for any set of M flight conditions in the aircraft's flight envelope.

Once the additional air data parameters for the sensor have been determined at the air data neural network 420, the additional air data parameters are output to any other component of the aircraft that can make use of this data. The output is illustrated by element 220. However, in order to determine if there is a fault in any sensor 410, the system 400 performs a fault check. In the embodiment illustrated in FIG. 4, a number of the additional air data parameters generated using neural network or other artificial intelligence 420, are fed into a second process to determine if there is a fault. In one embodiment the additional air data parameters of AOA, AOS and predicted Mach are provided to the inverse look-up table 430. However, other parameters can be used.

Inverse look up table 430 is a multidimensional look-up table where any of the air data values can be predicted from the receipt of the remaining data points. In the embodiment illustrated in FIG. 4 the inverse look-up table 430 is a 3-D table where the predicted pressure can be determined from the receipt of data related to AOA, AOS and predicted Mach. In one embodiment the inverse look-up table 430 is generated from the data originally used to train the air data neural network 420. However, in other embodiments the look-up table 430 can be generated from other data. The predicted pressure associated with the inputted additional air data parameters is illustrated at step 530.

Once the predicted pressure is obtained from the inverse look-up table 430 at step 530, the measured pressure and the predicted pressure are compared at comparing module 440. This step can be carried out for each of the measured pressures obtained from sensors 410. The comparing module 440 merely compares the predicted and measure pressure according to a predetermined method to generate a fault detection value for a particular sensor. In one embodiment, the comparing module 440 subtracts the predicted pressure from the measure pressure to generate the fault detection value. However, other approaches to comparing the pressures can be used. This comparing process is illustrated at step 540.

The results of the comparing process of step 540 are provided to a fault detection neural network 450 at step 550. The fault detection neural network 450 is a second neural network that has been trained to identify faults in the data. This process is useful because comparing the predicted pressure to a measured pressure for an individual sensor 410 does not adequately identify failures since there is almost always a systemic offset between the two that changes with all of the input pressures. This is primarily due to the fact that the flight condition parameters used to look-up the predicted pressure were calculated with all of the pressures. The neural network 450 takes into consideration all of the other measured pressures in the analysis of a fault. The determination of a fault is output at step 560 and shown at reference number 230. The fault information 230 provided by the fault detection neural network 450 is in one example generated using a neural network such as the one illustrated in FIG. 3 above but with the described inputs. However, in alternative embodiments network 450 can use other artificial intelligence algorithms.

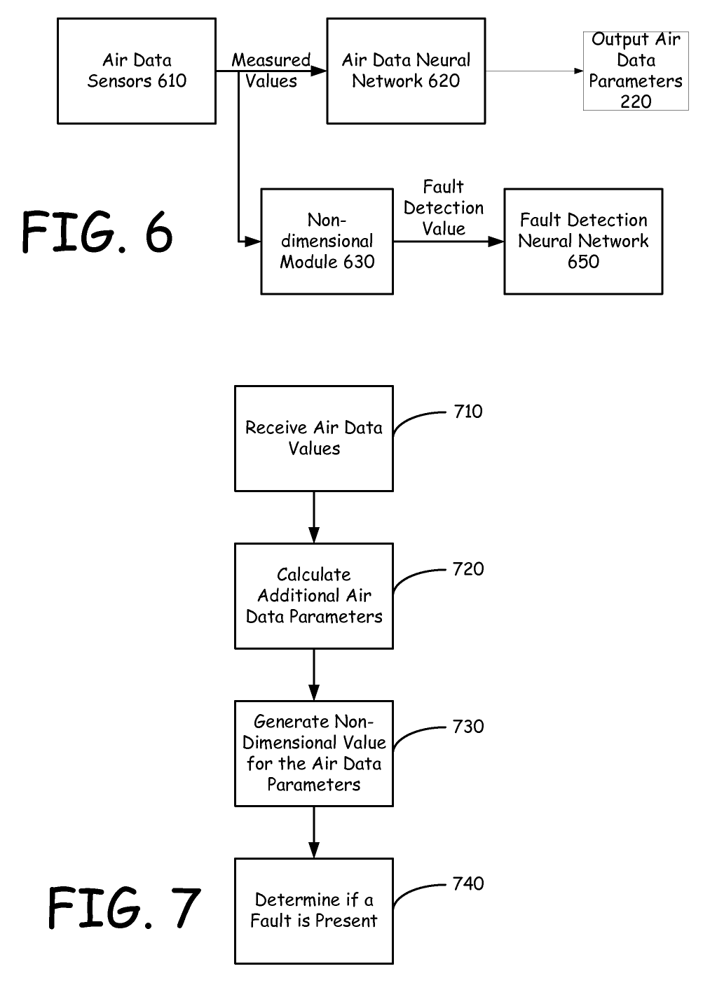

FIG. 6 is a block diagram illustrating the process and components for determining a fault according to one embodiment of the present invention. FIG. 7 is a flow diagram that illustrates the steps performed according to the embodiment of FIG. 6.

At the first step a plurality of air data sensors 610 each generate an air data value. In one embodiment the air data values are a measured pressure. However, any other air data values can be used. Once the air data values have been generated or received, the sensors 610 pass this data to an air data neural network 620. This is illustrated at step 710.

The air data neural network 620 receives the measure pressures from the air data sensors 610. From these measured pressures the air data neural network 620 calculates a number of additional air data parameters such as the free stream flight conditions. In one embodiment the air data neural network 620 calculates four additional parameters. Those parameters can include static pressure (Ps), impact pressure (Qc), angle of attack (AOA), and angle of slip (AOS). However, the air data neural network can calculate more or less additional parameters. Further, network 620 can calculate other air data parameters. The calculation of the additional parameters is illustrated at step 720.

Using a flight envelope of a given aircraft a training data set can be generated using a set of look-up tables to predict the pressures observed on each of the pressure ports 610. By selecting a specific flight condition with the flight envelope these envelope parameters can be input into the look-up tables to generate N pressures. (Where N is the number of sensors 610). During training of the air data neural network 620, a simulated error is applied to one or the sensors 610 and the pressures=output from the pressure sensors 610 are converted to non-dimensional values. This results in a set of input values which can be fed into either the air data neural network 620 or the fault detection neural network 650.

Utilizing this set of pressures, including the simulated error, the air data parameters are predicted using the neural network 620. This comparison of the predicted air data parameters with the actual air data parameters allows for the generation of target training points. Each point is bassed off of the shift in the predicted air data parameters to truth air data parameters. This training approach is then used to train the fault detection neural network to predict when a given sensor 610 is providing an erroneous value.

At the same time the air data neural network 620 is determining the additional air data parameters, the measured pressure is also provided to a module 630 that is configured to convert the measured pressure to a non-dimensional fault detection value. In one embodiment the module 630 takes all of the measured pressures received from sensors 610 and generates an average pressure value for all of the sensors 610 that are providing pressure data to the neural network 620. This is referred to as P_{avg}. Then the measured pressure Pₘ for one of the sensors 610 is compared against the average value. In one embodiment Pₘ is divided by P_{avg}. This, represents the non-dimensional value for the measured pressure Pₘ. This non-dimensional value is then input into the fault detection neural network 650. This is illustrated at step 730.

The fault detection neural network 650 processes the non-dimensional value to determine if the associated sensor 610 has a fault. In one embodiment the fault detection neural network 650 processes the non-dimensional value to obtain a value which can be plotted against a tansig value. However, other approaches can be used.

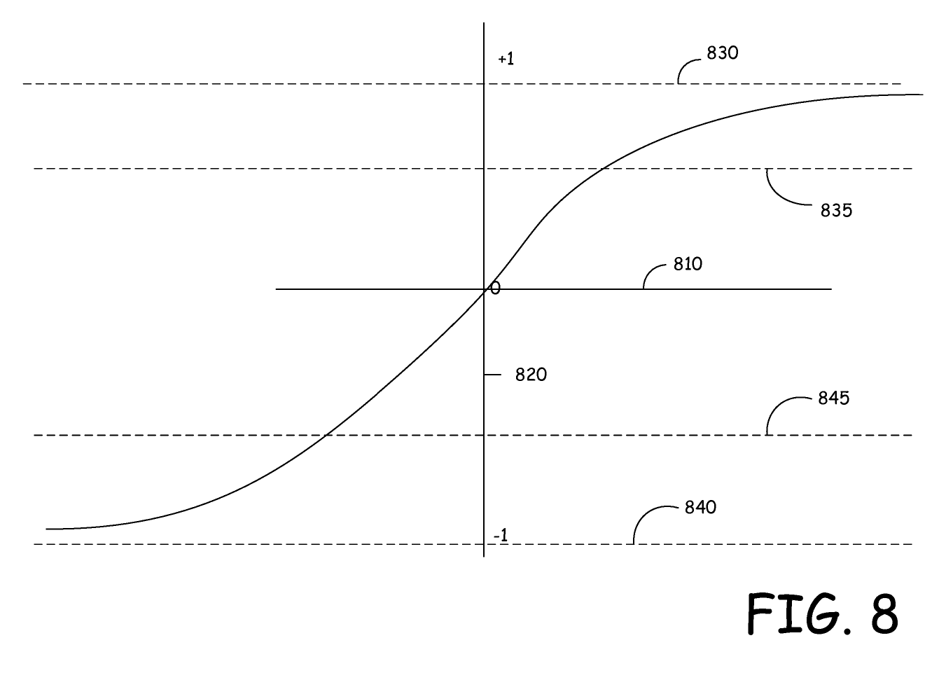

An example of a tansig graph is illustrated at FIG. 8. In FIG. 8 the y-axis 820 represents the processed value through the fault detection neural network, and the x-axis 810 represents the measured pressure error, or other air data parameter. Lines 830 and 840 represent values along the y-axis 820 on which the tansig equation asymptotically approaches. In one embodiment this value is ±1. However other values can be used. Lines 835 and 845 represent the values for the tansig equation where a fault is determined. In one embodiment the value is set at ±0.85. Once again any other values can be used for the fault value. While fault detection neural network 650 is illustrated above using a tansig operation any other process which can determine fault can be used in network 650. The determination of a fault is illustrated at step 740.

Although the present invention has been described with reference to preferred embodiments, workers skilled in the art will recognize that changes may be made in form and detail without departing from the spirit and scope of the invention.

1. A method of providing fault isolation in an air data system which uses artificial intelligence to generate air data parameters, the method comprising:
receiving an air data pressure value from at least one air data sensor;
generating a fault detection value based upon the received air data pressure value,
wherein generating the fault detection value further comprises:
generating a predicted value for the received air data pressure value; and
comparing the received air data pressure value with the predicted value to generate the fault detection value; and determining if a fault is present by processing the fault detection value through a fault
detection network having artificial intelligence.

2. (canceled)

3. The method of claim 1, wherein generating the predicted value for the received air data pressure value further comprises:
receiving additional air data parameters for the at least one air data sensor; and
searching a database of air data parameter values to identify an air data pressure value associated with the additional air data parameters.

4. The method of claim 3, wherein the database is an inverse look-up table.

5. The method of claim 4, wherein the inverse look-up table is an M-dimensional database, where M is equal to the number of additional air data parameters.

6. The method of claim 3, wherein the data stored in the database is data that is used to train the artificial intelligence of the air data system.

7. The method of claim 1, wherein comparing the predicted value with the received air data pressure value further comprises:
calculating a difference between the received air data pressure value and the predicted value.

8. (canceled)

9. A method of providing fault isolation in an air data system which uses artificial intelligence to generate air data parameters, the method comprising:
receiving a plurality of air data pressure values, each air data pressure value associated with a different air data sensor;
generating a fault detection value based upon at least one received air data pressure value, wherein generating the fault detection value further comprises:
creating a non-dimensional value for one of the plurality of received air data pressure values; and
processing the non-dimensional value for the one of the plurality of received air data pressure values through an artificial intelligence fault detection network.

10. The method of claim 9, wherein creating the non-dimensional value for one of the plurality of received air data pressure values further comprises:
averaging the plurality of received air data pressure values; and
dividing the one of the plurality of received air data pressure values by an average value of the plurality of received air data pressure values.

11. An air data system comprising:
a plurality of pressure sensing ports each providing one of a plurality of measured pressures; and
air data computer circuitry configured to use artificial intelligence to generate air data parameters as a function of the plurality of measured pressures, and configured to use artificial intelligence having a fault detection value as an input to identify a fault in one of the plurality of air data sensing ports.

12. The air data system of claim 11, wherein the air data computer circuitry is further configured to generate a predicted value for one of the measured pressures and to identify a fault based on processing a difference between the one of the measured pressures and the predicted value.

13. The air data system of claim 12, wherein the air data computer circuitry is configured to generate the predicted value for one of the measured pressures based on the generated air data parameters for an associated pressure port.

14. The air data system of claim 13, wherein the predicted value for the one of the measured pressures is generated from a database.

15. The air data system of claim 14, wherein the database is an M-dimensional inverse look-up table, where M is equal to the number of air data parameters calculated for a given measured pressure.

16. The air data system of claim 11, wherein the air data computer circuitry is further configured to generate a non-dimensional input, for each of the plurality of measured pressures, to the artificial intelligence to identify a fault.

17. The air data system of claim 16, wherein the non-dimensional input is generated by dividing one of the plurality of measured pressures by an average of the plurality of measured pressures.
